(19) United States
(12) Patent Application Publication
(10) Pub. No.: US 2006/0065095 A1
(43) Pub. Date: Mar. 30, 2006

(54) Roll dispenser and storage product

(76) Inventor: Michael Ambrose, Santa Barbara, CA (US)

Correspondence Address: Michael Ambrose, PO Box 267, Summerland, CA, 93067, US

(21) Appl. No.: 10/954,513

(22) Filed: Sep. 30, 2004

(51) Int. Cl. B26D 7/00

(52) U.S. Cl. 83/650; 225/93

(57) ABSTRACT

The invention is a dispensing and storage product for storing rolls of items and dispensing items unrolled from the rolls. The invention is designed to dispense unrolled items while retaining the rolls of items within the product. The product provides a dispensing section for dispensing rolls and separate storage section sized to store a plurality of storage rolls. The dispensing section and the storage section are isolated from each other to enable only authorized users to restock the dispensing rolls from the on-hand storage rolls.

The invention is a dispensing and storage product for storing rolls of items and dispensing items from the rolls of items. The product securely stores a dispensing roll and storage rolls and controllably dispenses items unrolled from the dispensing roll.

The product can be used to dispense items unrolled from the dispensing roll, while the items remaining on the roll are protected and secured within the product.

In addition to dispensing items, the product can store one or more storage rolls within the product for eventual dispensing. While being stored, the one or more storage rolls are isolated from the dispensing roll, preventing any problematic interaction between the storage roll and the items being dispensed.

The product can be utilized with both cored and coreless rolls, that is, for rolls comprised of items rolled around a hollow core, and for rolls comprised of items rolled together without a hollow core.

The product can dispense items unrolled from rolls of items when the items are separate and interleaved. Alternatively, the product can dispense items unrolled from rolls of items when the items are separably connected together; for example, by perforating, scoring, and various other separable connections.

The product is especially useful for commercial applications; for example, for hotel housekeeping services, hospitality services, health club installations, office cleaning services, and various commercial applications where waste and pilferage of rolls of items is problematic.

The product restricts access to the rolled items by enabling the dispensing of unrolled items only and by retaining the rolls within the product.

At the same time, the product can store additional rolls at the dispensing location, enabling the dispensers to be re-stocked as required from on-hand storage rolls.

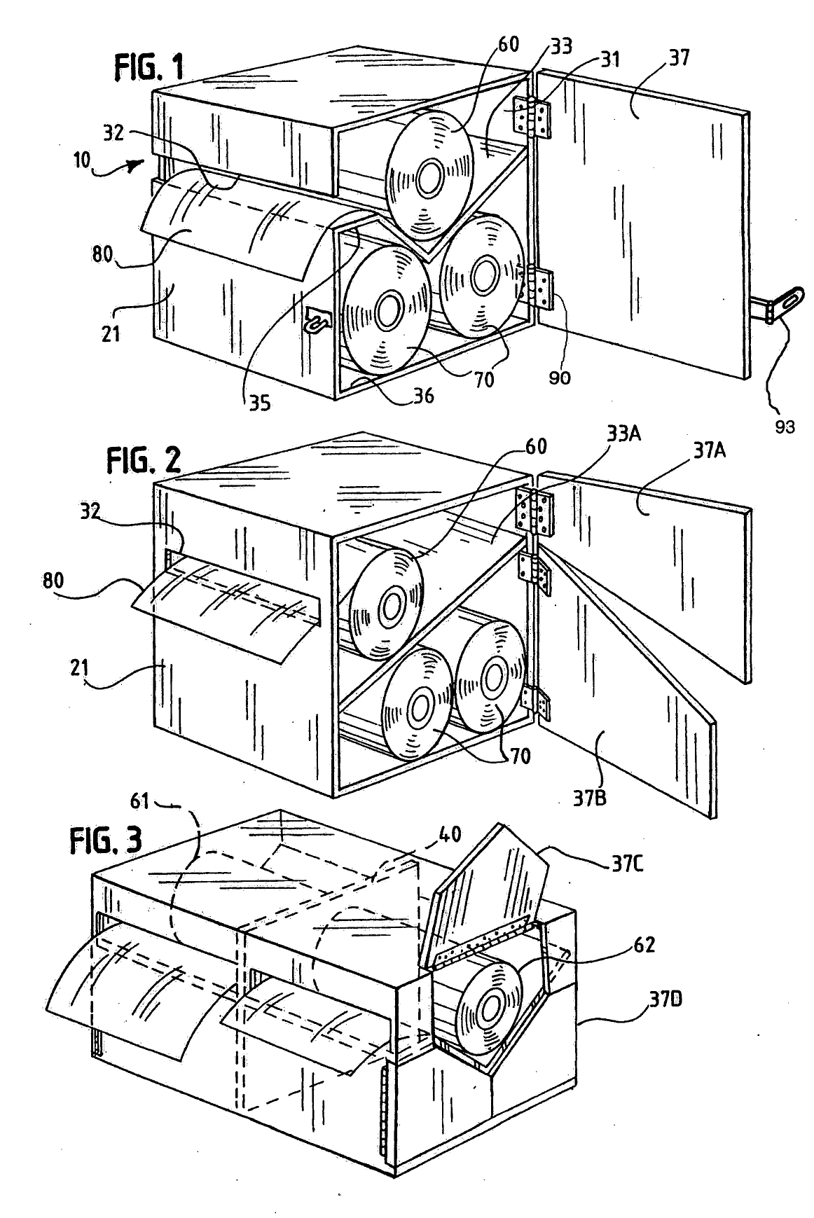

FIG. 1 depicts a perspective view of a product in use.

FIG. 2 depicts a perspective view of different embodiment of the product in use.

FIG. 3 depicts a perspective view of another embodiment of the product.

FIG. 4 depicts a perspective view of a guide and cradle in use.

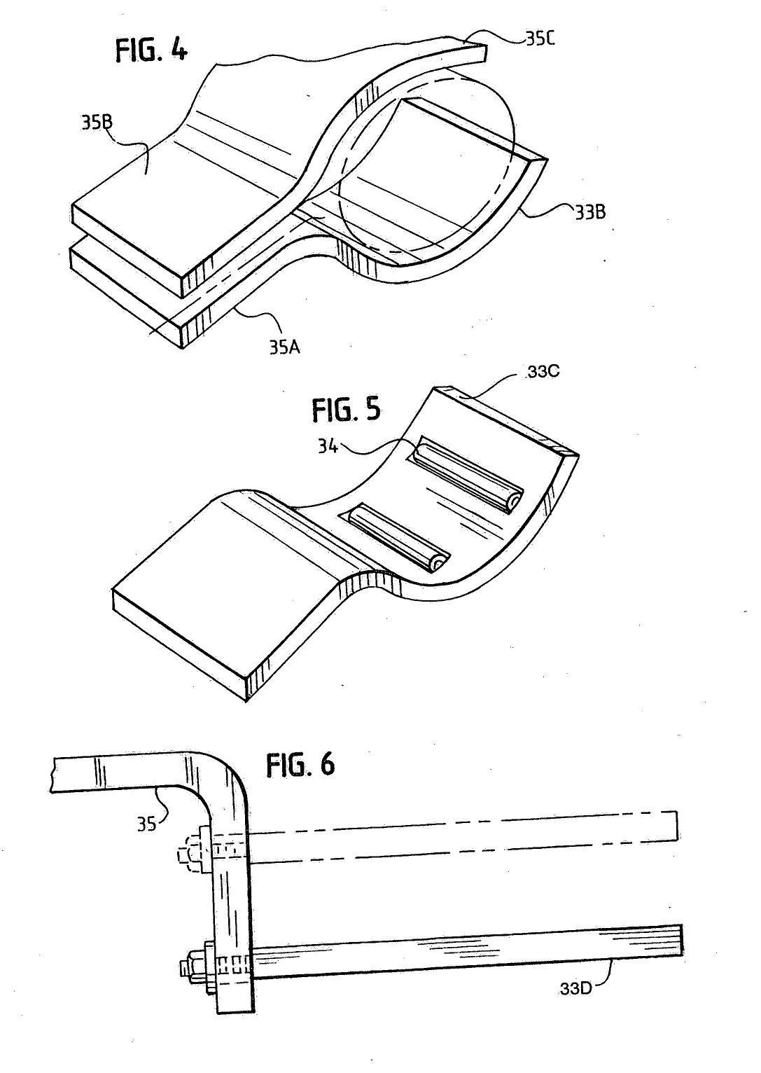

FIG. 5 depicts a perspective view of a cradle with rollers.

FIG. 6 depicts a side view of an adjustable cradle.

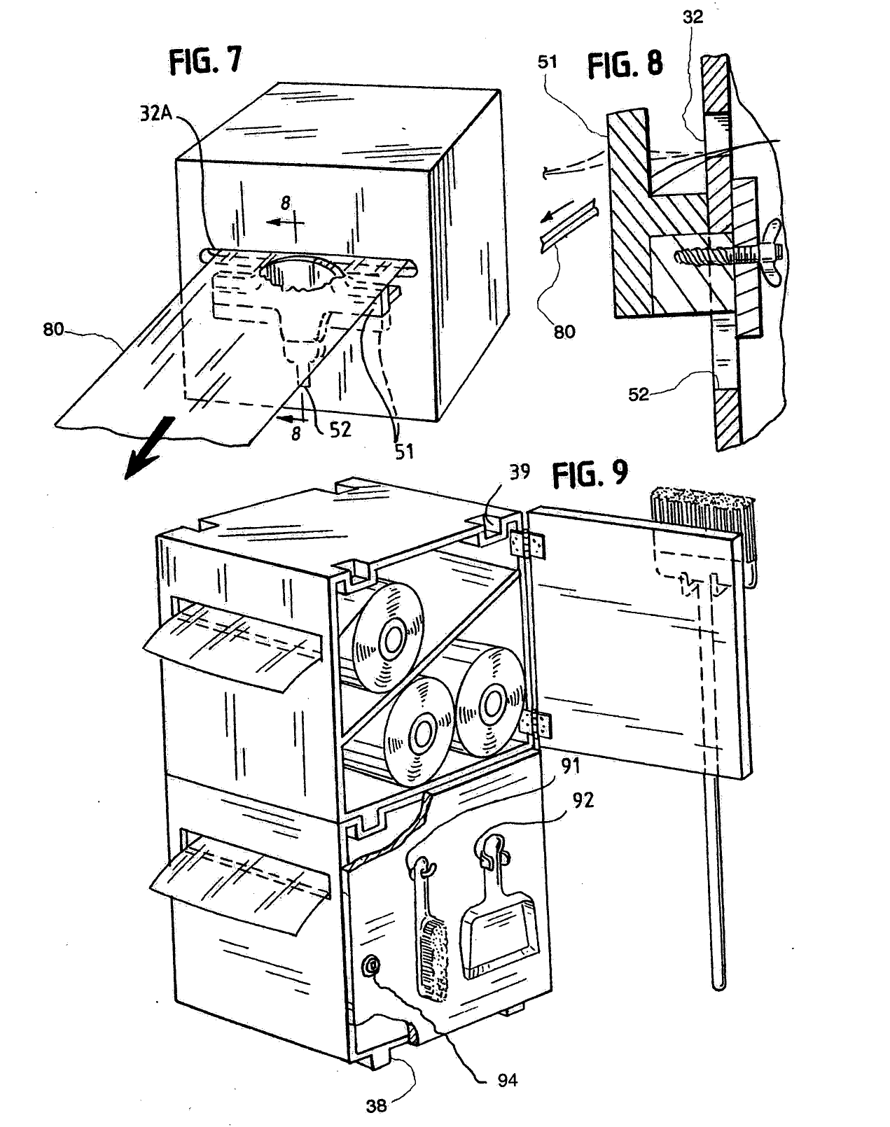

FIG. 7 depicts a perspective view of an embodiment of the product with an item separator.

FIG. 8 depicts a section view across line 8-8 in FIG. 7.

FIG. 9 depicts a perspective view of a stacked product installation.

The product comprises an enclosure. The enclosure securably contains the items and the rolls of items.

The enclosure can be made from various materials so long as the material is suitable for storing and for containing rolls. For example, the enclosure can be made from plastic, fiberglass, metal, vinyl, wood, and various other natural, synthetic, and semi-synthetic materials and combinations thereof.

In FIG. 1, the product 10 comprises the enclosure 21.

The enclosure comprises a dispensing section within the enclosure. The dispensing section contains the dispensing roll.

The dispensing section isolates the dispensing roll from the storage roll so that the storage roll cannot interfere with the dispensing roll and with the items that are unrolled from the dispensing roll.

In FIG. 1, the dispensing section 31 contains the dispensing roll 60. The dispensing section 31 isolates the dispensing roll 60 from the storage roll, such as the storage roll 70.

Interference between the dispensing roll and the storage roll can disrupt the item that is unrolled from the dispensing roll and prevent the item from exiting the enclosure.

Interference between the dispensing roll and the storage roll can be especially disruptive when the dispensing roll is comprised of items that are separate and interleaved.

The separate and interleaved items can separate prematurely if the dispensing roll is prevented from unrolling as the items are discharged out of the enclosure through the opening. Such premature separation of the items can prevent subsequent items from discharging through the opening.

The separate and interleaved items can separate prematurely if the unrolled items are disrupted and displaced before they are discharged out of the enclosure through the opening.

The dispensing section comprises an opening for discharging unrolled items from the enclosure.

The opening extends outward from the dispensing section through the enclosure and provides a passage for items to discharge out of the enclosure.

The opening in use discharges out of the enclosure the items unrolled from the dispensing roll, for example the item 80.

The opening is sized to discharge out of the enclosure items that are unrolled from the dispensing roll.

The opening is sized to retain the dispensing roll within the enclosure. Because the opening is sized to discharge items but not to discharge the substantially larger dispensing roll, the opening can retain the dispensing roll within the enclosure.

In FIG. 1, the dispensing section 31 has an opening 32.

The opening can have various shapes depending on the item that is discharged. For example, for discharging substantially flat items that are rolled into a substantially cylindrical roll, the opening can be sized to discharge the items edgewise.

The opening can also vary depending on the configuration of items on the roll. For example, the separate and interleaved items can require friction between adjacent items to continuously feed subsequent items through the opening.

Consequently, the separate and interleaved items can require a smooth and undisturbed transition from the roll through the opening.

Alternatively, the separably connected items, such as items joined by perforated seams, can be more robustly connected to adjacent items.

Due to the more robust connection between the adjacent separably connected items, the separably connected items can tolerate more interference while unrolling from the roll and discharging through the opening.

Consequently, the separably connected items can discharge via a smaller opening, for example a round hole, and still reliably discharge subsequent items through the opening.

Various shapes and sizes of openings can be utilized so long as the opening meets the functional requirements of discharging the items unrolled from the dispensing roll and of retaining the dispensing roll within the enclosure.

In the embodiment shown in FIG. 1, the opening 32 is long and narrow for discharging substantially flat items edgewise.

The dispensing section further comprises a cradle for positioning the dispensing roll with respect to the opening.

In FIG. 1, the dispensing section 31 has a cradle 33. The cradle 33 optimally positions the dispensing roll 60 with respect to the opening 32 to facilitate smoothly discharging items from the opening 32.

The cradle is designed to facilitate the dispensing roll smoothly rotating as the items are unrolled from the dispensing roll. Also, the cradle is designed to limit dispensing roll translation within the dispensing section.

The dispensing roll should rotate easily within the cradle, as the items are unrolled, so that the dispensing roll remains optimally positioned with respect to the opening.

Rough and jerky rotating can cause the dispensing roll to wander and deviate from an optimal position with respect to the opening.

Trouble-free dispensing roll rotation is especially important when the dispensing roll is comprised of items that are separate and interleaved.

Rough and jerky rotating can cause separate and interleaved items to prematurely separate from subsequent items and disrupt continuous feeding through the opening. Dispensing roll translation can cause the dispensing roll to deviate from the optimal position with respect to the opening.

The cradle can have various shapes.

In FIG. 1, the cradle 33 is substantially V-shaped.

In FIG. 2, the cradle 33A is flat and angled.

In FIG. 4 and FIG. 5, the cradles 33B and 33C, respectively, are substantially C-shaped.

Alternatively, the cradle can be L-shaped, U-shaped and various other shapes and combinations thereof.

The cradle can further comprise roll-promoting components, for example, rollers, bearings, low-friction material inserts, and various other anti-friction components and combinations thereof. In FIG. 5, the cradle 33C has roll-promoting components, such as the roller 34.

Alternatively, the cradle can be adjustable for accommodating different sized dispensing rolls. In FIG. 6, the cradle 33D can be adjusted up and down to accommodate different sized dispensing rolls.

The dispensing section can further comprise a guide. The guide is positioned between the cradle and the opening and facilitates the items unrolled from the dispensing roll smoothly passing from the cradle to the opening.

The guide can provide support and guidance to items unrolled from the dispensing roll before the items discharge from the opening.

The guide can support the unrolled items as they travel from the dispensing roll to the opening and can prevent items from interfering with, and re-engaging with the dispensing roll and from becoming entangled inside the enclosure.

In FIG. 1, the guide 35 is positioned between the opening 32 and the cradle 33. The guide 35 supports and guides the items, such as the item 80. The guide 35 is a substantially planar platform.

Alternatively, the guide can comprise two spaced apart substantially planar platforms so that the path from the cradle to the opening is substantially shielded from above and supported from below.

Alternatively, the guide can comprise four substantially planar platforms positioned to form a hollow area between the cradle and the opening, the items in use passing through the hollow area and discharging from the opening out of the enclosure.

Alternatively, the guide can comprise other components having various shapes and sizes, so long as the guide meets the functional requirements of supporting and guiding the items between the dispensing roll and the opening.

In FIG. 4, the guide comprises a substantially planar platform 35A connected to the C-shaped cradle 33B, a substantially planar platform 35B spaced apart from and above the platform 35A, and a curved shroud 35C positioned above the cradle 33B.

The dispensing roll can comprise a first dispensing roll and a second dispensing roll.

To facilitate dispensing items from the first dispensing roll and the second dispensing roll, the dispensing section can further comprise a divider.

The divider divides the dispensing section so that the dispensing section can separately dispense items from the first dispensing roll and from the second dispensing roll.

The divider isolates the first dispensing roll from the second dispensing roll to prevent interference between the first dispensing roll and the second dispensing roll.

In FIG. 3 the dispensing section comprises the divider 40, which isolates the first dispensing roll 61 from the second dispensing roll 62.

The enclosure further comprises a storage section. The storage section is sized to hold a plurality of storage rolls.

The storage section is isolated from the dispensing section within the enclosure so that the storage rolls cannot interfere with the dispensing roll and the items unrolled from the dispensing roll.

In FIG. 1, the enclosure 21 has the storage section 36. The storage section 36 holds storage rolls; such as the storage roll 70.

The enclosure further comprises a door connected to the enclosure. The door provides access to the dispensing section and to the storage section. The door moves between an open position and a closed position.

The door in the open position enables transferring the storage roll from the storage section to the dispensing section.

The door can be pivotally connected to the enclosure and pivot between the open position and the closed position.

In FIG. 1, the enclosure 21 has a door 37. The door 37 is pivotally connected to the enclosure via hinges, such as the hinge 90.

Alternatively, the door can be slidingly connected to the enclosure and the door can slide between the open position and the closed position.

Alternatively, the door can be connected to the enclosure via various other connections and combinations thereof, so long as the door has an open position and a closed position and so long as the door provides access to the dispensing section and to the storage section.

The door can have more that one door component; for example, a first door component and a second door component.

The first door component can move between a first door open position and a first door closed position.

The second door component can move between a second door open position and a second door closed position.

The first door component can move independently of the second door component and vice versa.

In FIG. 2, the enclosure has a first door component 37A and a second door component 37B.

In FIG. 3, the enclosure has a first door component 37C and a second door component 37D.

In FIG. 1 and FIG. 2, the door is shown providing access to the enclosure via an enclosure side.

Alternatively, the door can provide access via an enclosure top, bottom, front, back, and combinations thereof.

The door can have a lock for locking the door to limit access to the dispensing section and to the storage section to authorized users.

In FIG. 1 the lock 93 is a hasp. Alternatively, in FIG. 9 the lock 94 is a key-operated cam lock.

Alternatively, the lock can be a deadbolt, and a mortise lock.

Alternatively, the lock can be a combination lock.

Alternatively, the lock can have magnetic card key.

Alternatively, the lock can be any of various locking methods known in the art and providing the function of restricting access to the dispensing section and the storage section to authorized users.

The lock can have a first lock component for locking a first door component and a second lock component for locking a second door component.

The enclosure can have mating halves to facilitate stably stacking more than one product.

The mating halves can facilitate vertical stacking and can facilitate horizontal stacking.

The mating halves can comprise a first mating half and a second mating half.

The first mating half and the second mating half can be positioned on opposing enclosure surfaces. The first mating half and the second mating half are designed to coincide with the second mating half and the first mating half, respectively, of adjacent stacked enclosures.

The mating halves are designed so that the mating halves of the adjacent stacked enclosures interact to inhibit relative movement between the adjacent stacked enclosures.

As shown in FIG. 9, the enclosure can have a protrusion-shaped first mating half 38 on a bottom side designed to mate with an indentation-shaped second mating half 39 on a top side of the adjacent stacked enclosure.

The interacting protrusion-shaped first mating half 38 and the indentation-shaped second mating half 39 can limit sliding between the adjacent stacked enclosures and can provide increased stability when stacking more than one product.

Alternatively, the enclosure can have various mating halves for facilitating stable stacking. For example, the mating halves can comprise snaps, a hook and eye pair, cohesive strips, a hook and loop pair, and various commercially-available mating halves and combinations thereof.

Alternatively, the mating halves can comprise various custom-designed mating halves and combinations thereof.

The mating halves can be integral to the enclosure. Alternatively, the mating halves can be separate from and connected to the enclosure.

The enclosure can have an accessory support for attaching an accessory to the enclosure. For example, the enclosure can have an accessory support for attaching a broom, a mop, a dustpan, and various other housekeeping and hospitality accessories to the enclosure.

Alternatively, the enclosure can have an accessory support for attaching a towel, a hairdryer, a razor, and various other accessories typically used in a health club.

Alternatively, the enclosure can have an accessory support for attaching various accessories depending on the application and venue where the enclosure is utilized.

The accessory support can comprise a snap, a hook, a hook and loop pair, a clip, and various commercially-available accessory supports and combinations thereof.

As shown in FIG. 9, the enclosure has accessory supports; for example, the hook support 91 and the clip support 92.

Alternatively, the accessory support can comprise various custom-designed accessory supports and combinations thereof.

The accessory support can be integral to the enclosure. Alternatively, the accessory support can be separate from and connected to the enclosure.

The enclosure can further comprise an item separator for separating the items discharged through the opening from the subsequent items discharged through the opening. The item separator can be especially useful for separating the separably connected items from the subsequent separably connected items.

The item separator can be movably connected to the enclosure and be movable between an active position and an inactive position.

The item separator in use can be in the active position for separating the separably connected items. The item separator in use can be in the inactive position when the product is dispensing the separate and interleaved items.

As shown in FIG. 7 and FIG. 8, the enclosure has an item separator 51 slidably connected outward and proximal the opening 32A. The item separator 51 moves between the active position and the inactive position along the slot 52.

The item separator can be slidably connected and pivotally connected. Alternatively, the item separator can be connected in various other ways so that the item separator is movable between an active position and an inactive position.

The item separator can comprise a rigid edge connected to the enclosure and positioned outward from the opening. Separably connected items can be discharged through the opening and pulled across the item separator rigid edge so that the items separate from subsequent items where the items are separably connected.

Alternatively, the item separator can comprise a serated edge.

Alternatively, the item separator can comprise a plurality of item separator components.

The enclosure can further comprise mounting means for mounting the enclosure to a wall, a counter top, a bench, and other surfaces.

The mounting means can comprise hooks, hook and loop pairs, clips, adhesives, and various other mounting means.

The mounting means can be integral to the enclosure.

Alternatively, the mounting means can be separate from and connectable to the enclosure.

1. A dispensing and storage product for dispensing items that are organized into rolls of items and for storing the rolls of items, the rolls of items comprising a dispensing roll and a storage roll, the product in use for storing the storage roll and for dispensing items that are unrolled from the dispensing roll, the product comprising:
an enclosure for holding the items and the rolls of items and for limiting access to the items and the rolls of items;
the enclosure comprising:
a dispensing section within the enclosure,
the dispensing section in use containing the dispensing roll;
the dispensing section comprising:
an opening,
the opening extending from the dispensing section through the enclosure;
the opening being sized to discharge from the enclosure items that are unrolled from the dispensing roll;
the opening being sized to retain the dispensing roll within the enclosure;
a cradle,
the cradle for positioning the dispensing roll with respect to the opening;
the cradle in use promoting dispensing roll rotation as items are unrolled from the dispensing roll;
the cradle in use limiting dispensing roll translation with respect to the opening;
a storage section within the enclosure,
the storage section in use containing the storage roll;
the storage section being sized to hold a plurality of storage rolls;
the storage section isolating the storage roll from the dispensing roll;
a door connected to the enclosure,
the door moving between an open position and a closed position; and
the door in use in the open position enabling transferring the storage roll from the storage section to the dispensing section.

2. The dispensing and storage product of claim 1 wherein the door further comprises:
a lock,
the lock for locking the door and to restrict access to the dispensing section and to the storage section.

3. The dispensing and storage product of claim 1 wherein the door comprises:
a first door component; and
a second door component.

4. The dispensing and storage product of claim 1 wherein the door comprises:
a first door component;
a second door component;
and wherein the door further comprises:
a first lock component for locking the first door component; and
a second lock component for locking the second door component.

5. The dispensing and storage product of claim 1 wherein the enclosure further comprises:
an item separator for separating discharged items,
the item separator separating items that are separably connected.

6. The dispensing and storage product of claim 1 wherein the cradle is an adjustable cradle for positioning variously sized rolls.

7. The dispensing and storage product of claim 1 wherein the dispensing roll comprises:
a first dispensing roll;
a second dispensing roll;
and wherein the dispensing section further comprises:
a divider,
the divider positioned within the dispensing section; and
the divider isolating the first dispensing roll from the second dispensing roll to prevent interference between the first dispensing roll and the second dispensing roll.

9. A dispensing and storage product for dispensing items that are organized into rolls of items and for storing rolls of items, the rolls of items comprising a dispensing roll and a storage roll, the product for storing the storage roll and for dispensing items that are unrolled from the dispensing roll, the product comprising:
an enclosure for holding the items and the rolls of items and for limiting access to the items and the rolls of items;
the enclosure comprising:
a dispensing section within the enclosure,
the dispensing section in use containing the dispensing roll;
the dispensing section comprising:
an opening,
the opening extending from the dispensing section through the enclosure;
the opening being sized to discharge from the enclosure items that are unrolled from the dispensing roll;
the opening being sized to retain the dispensing roll within the enclosure;
a cradle,
the cradle for positioning the dispensing roll with respect to the opening;
the cradle in use promoting dispensing roll rotation as items are unrolled from the dispensing roll;
the cradle in use limiting dispensing roll translation with respect to the opening;
a guide positioned between the cradle and the opening;
the guide for guiding and supporting the items between the cradle and the opening;
a storage section within the enclosure,
the storage section in use containing the storage roll;
the storage section being sized to hold a plurality of storage rolls;
the storage section isolating the storage roll from the dispensing roll; and
a door connected to the enclosure,
the door moving between an open position and a closed position; and
the door in use in the open position enabling transferring the storage roll from the storage section to the dispensing section.

9. The dispensing and storage product of claim 8 herein the door comprises:
a first door component; and
a second door component.

10. The dispensing and storage product of claim 8 wherein the door comprises:
a first door component;
a second door component;
and wherein the door further comprises:
a first lock component for locking the first door component; and
a second lock component for locking the second door component.

11. The dispensing and storage product of claim 8 wherein the enclosure further comprises:
an item separator for separating discharged items,
the item separator separating separably connected items.

12. The dispensing and storage product of claim 8 wherein the cradle is an adjustable cradle for positioning variously sized rolls.

13. The dispensing and storage product of claim 8 wherein the dispensing roll comprises:
a first dispensing roll; and
a second dispensing roll;
and wherein the dispensing section further comprises:
a divider,
the divider positioned within the dispensing section; and
the divider isolating the first dispensing roll from the second dispensing roll to prevent interference between the first dispensing roll and the second dispensing roll.
